(19) United States
(12) Patent Application Publication
(10) Pub. No.: US 2009/0057115 A1
(43) Pub. Date: Mar. 5, 2009

(54) Illuminated Switch

(75) Inventors: Kazuyuki Mada, Chiba (JP); Makoto Yanaka, Chiba (JP); Atsushi Saito, Chiba (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Seiko Precision, Inc,, Chibo (JP)

(21) Appl. No.: 11/909,777

(22) PCT Filed: Mar. 27, 2006
(86) PCT No.: PCT/JP2006/306196

§ 371 Date: Sep. 26, 2007

(30) Foreign Application Priority Data
Mar. 30, 2005 (JP) 2005-098615

(51) Int. Cl. H01H 9/00

(52) U.S. Cl. 200/310

(57) ABSTRACT

An illumination switch is provided which can satisfactorily shield electromagnetic wave noise caused to emanate from an EL sheet and with which an excellent click feeling can be obtained. The illumination switch (10) is provided with a substrate (11), a switch pattern (12) formed on the substrate (11) and an EL sheet (14) which is formed so as to face the switch pattern (12) and to cover the movable contact (13) set up to be detachable on the switch pattern (12), the substrate (11) and the movable contact (13). The EL sheet (14) is provided with a shield layer (27) which shields the noise wherein the shield layer (27) is provided with an opening (27a) formed in the region facing the movable contact (13).

### TECHNICAL FIELD

The present invention relates to an illumination switch that uses an EL (electro-luminescence) sheet.

### BACKGROUND ART

The existence of devices up to now with switch key parts formed from transparent member and with backlights set up on the back faces so that the switch keys of portable electronic devices such as portable phones and electronic notepads can operate even in the dark is well known. An EL sheet is an example of the light source used for the backlight.

An EL sheet emits light by having an AC voltage of, for example, 20 to 200 Vrms and 200 Hz to 1 Kh applied. Because of the high frequency and high voltage for emission, this type of EL sheet produces electromagnetic wave noise and concerns have been raised about the deleterious effect the EL sheet has on the electronic device it is installed in.

Consequently, as shown in FIG. 3, an illumination switch 80 has been developed comprising an elastic sheet 81 which functions as a shield layer and is formed from the elastic material that the electroconductive material is compounded with and which shields the electromagnetic noise caused to be emitted from the EL element (e.g. Patent Literature 1).

As shown in FIG. 3, the illumination switch 80 is composed of an elastic sheet 81, an EL sheet 82, a switch sheet 83, an electrode 84, an adhesive layer 85 and a substrate 86. The elastic sheet 81 is formed between the EL sheet 82 and the switch sheet 83 and shields the electromagnetic noise emitted from the EL sheet 82.

When the EL sheet 82 is depressed by the switch key (not shown in the diagram) which is formed in a position opposite to the protruding part 82a formed on the EL sheet 82, the protruding part 82a is pushed out in the lower direction, the dome shaped region formed by the elastic sheet 81 and the switch sheet 83 is elastically deformed and the electrode 84 is deformed. Because of the deformation of the electrode 84, the switch pattern (not shown in the diagram) formed on the substrate 86 is electrically conducted and a voltage is impressed on the EL sheet 82.
Patent Literature 1: Unexamined Japanese Patent Application KOKAI Publication No. 2004-253217

### DISCLOSURE OF INVENTION

### Problem to be Solved by the Invention

In the illumination switch 80 disclosed in Patent Literature 1, because an elastically deformed elastic sheet 81 is also formed in the region that functions as the switch, the stiffness of the switch portion is strengthened, a satisfactory click feeling is not obtained and the switch cannot be caused to operate.

Consequently, an illumination switch which can effectively shield the electromagnetic noise caused to emanate from an EL sheet and with which a satisfactory click feeling can be obtained has been sought.

With the above situation in mind, the objective of this invention is to provide an illumination switch that can shield electromagnetic wave noise caused to emanate from an EL sheet and with which a satisfactory click feeling can be obtained.

In order to achieve the above stated objective, the illumination switch pertaining to the first aspect of this invention comprises a substrate, a switch pattern formed on the substrate, an electrode that faces the switch pattern and is set up to be detachable on the switch pattern, and an EL (electro-luminescence) sheet formed so as to cover the substrate, the switch pattern and the electrode, wherein a shield layer to shield the electromagnetic wave noise is set up on the EL sheet and an opening is formed in the shield layer in the region opposite to the electrode.

The EL sheet may have a dome shaped region formed so as to cover the switch pattern and the electrode and may have a sheet shaped region formed so as to cover the substrate.

The opening of the shield layer may be almost the same diameter as the dome shaped region.

The opening of the shield layer may be formed in the range that contains at least the dome shaped region.

The opening of the shield layer may be formed at the apex of the dome shaped region.

According to this invention, by setting up on the EL sheet a shield layer which has an opening in the region facing the electrode which is set up to be detachable on the switch pattern, it is possible to provide an illumination switch which satisfactorily shields the electromagnetic wave noise caused to be emitted from the EL sheet and obtains an excellent click feeling.

### BRIEF DESCRIPTION OF DRAWINGS

FIG. 1 is a cross-sectional diagram of the illumination switch pertaining to the embodiment of this invention.

FIG. 2 is a plane view of the illumination switch pertaining to the embodiment of this invention.

FIG. 3 is a cross-sectional diagram showing a conventional illumination switch.

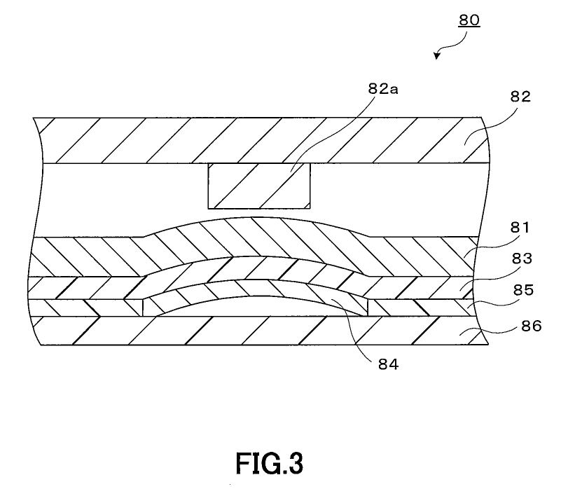

### EXPLANATION OF REFERENCE NUMERALS

10: Illumination switch
11: Substrate
12: Switch pattern
13: Movable contact
14: EL sheet
15: Adhesive layer
21: Surface protective film
22: Transparent electrode
23: Luminous layer
24: Insulation layer
25: Back plate
26: Electrode insulation layer
27: Shield layer
28: Tooth-back protective film

### BEST MODE FOR CARRYING OUT THE INVENTION

A detailed explanation will now be given using the diagrams regarding the illumination switch pertaining to the embodiment of this invention.

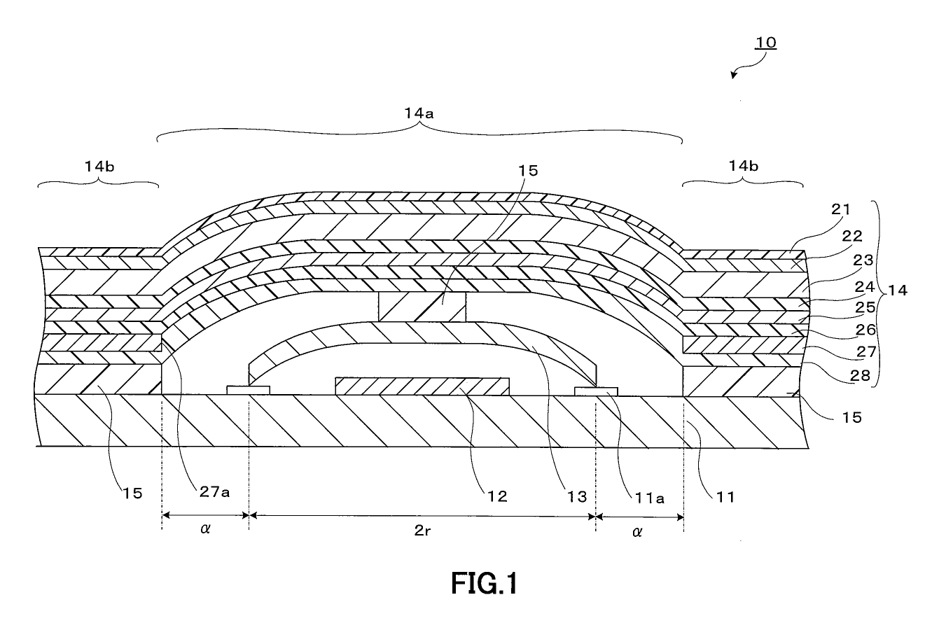

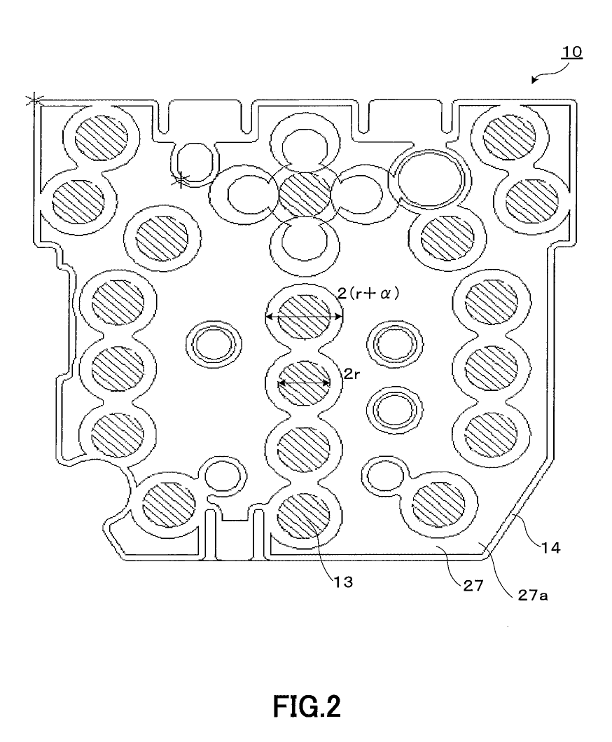

A cross-sectional diagram of the illumination switch 10 pertaining to the embodiment of this invention is given in FIG. 1. FIG. 2 is a plane diagram of the illumination switch 10. Furthermore, in order to make the explanation easier with FIG. 2, the movable contact 13, the EL (electro-luminescence) sheet 14 and the shield layer 27 formed inside the EL sheet 14 are particularly illustrated. The rest have been omitted.

As shown in FIGS. 1 and 2, the illumination switch 10 comprises a substrate 11, a switch pattern 12, a movable contact 13, an EL sheet 14 and an adhesive layer 15.

The substrate 11 is structured from a printed circuit board and a flexible printed circuit board. On the back of the substrate 11 a circuit (not shown in the diagram) has been formed for the electronic device that the illumination switch 10 is installed in. The EL sheet 14 is affixed to the substrate 11 by the adhesive layer 15 which is constructed from a polyethyl acetate and polyvinyl acetate family non-conducting adhesive agent. Furthermore, the fixed contact 11a on the substrate 11 is formed in a circle and the tip of the movable contact 13 is set up so as to come in contact with the fixed contact 11a.

The switch pattern 12 is constructed from highly electro-electroconductive metal such as carbon or silver and is formed on the substrate 11. The switch pattern 12 operates the contact point used for the switch. By having the circuit of the switch pattern 12 be electroconductive, an input signal is sent to the electronic device in which the illumination switch 10 is installed and the EL sheet 14 emits light.

The movable contact 13 is constructed from a mixture of a conducting material such as carbon powder in an elastic material such as polyurethane rubber and as shown in FIG. 1 is formed on the fixed contact 11a of the substrate 11. The planar shape of the movable contact 13 is formed in a circular dome shape. Additionally, the movable contact 13 is opposite to the switch pattern 12 and is set up on the fixed contact 11 a of the substrate 11 so as to be detachable. The movable contact 13 is affixed inside the dome part 14a of the EL sheet 14 through the adhesive layer 15. As a result, the movable contact 13 is also elastically deformed in keeping with the deformation of the dome part 14a of the EL sheet 14.

Furthermore, as shown in FIG. 2, there are numerous movable contacts 13 formed in the illumination switch 10. The diameter (2r) of the movable contact 13 is determined by the load on the movable contact 13 and in this embodiment is formed on the order of, for example, 4 mm.

The EL sheet 14 is composed of the surface protective film 21, the transparent electrode 22, the luminous layer 23, the insulation layer 24, the back plate 25, the electrode insulation layer 26, the shield layer 27 and the tooth-back protective film 28.

When an AC voltage is applied from the power source not shown in the diagram to the EL sheet 14, the luminous layer 23 of the EL sheet 14 emits light.

As shown in FIG. 1, the EL sheet 14 is affixed to the substrate 11 through the adhesive layer 15 which is composed from non-electroconductive adhesion material made of polyethyl acetate or polyvinyl acetate. Furthermore, as shown in FIG. 1, the EL sheet 14 is composed of the domed part 14a formed in a dome shape, whose planar shape is circular so as to cover the switch pattern 12 and the movable contact 13, and the sheet part 14b which is affixed to the substrate 11 through the adhesive layer 15.

As shown in FIG. 2, the domed part 14a of the EL sheet is plurally formed inside the EL sheet 14 and the domed part 14a is formed so as to be separated by a fixed amount (α) from the movable contact 13. Consequently, the diameter of the domed part 14a is formed so as to only be larger by 2α than the 2r diameter of the movable contact 13. The distance separated from the movable contact 13 is determined by the stiffness of the EL sheet 14, the load on the domed part 14a and the shape of the domed part 14a. Specifically, when, in this embodiment, the diameter of the movable contact 13 is approximately 4 mm, the diameter of the domed part 14a is formed to be approximately 6 mm in order to be separated from the movable contact 13 by on the order of 1 mm.

When the domed part 14a of the EL sheet 14 is depressed, the domed part 14a is elastically deformed and in keeping with this the movable contact 13 is also elastically deformed. When the movable contact 13 is elastically deformed, it approaches the substrate 11 and comes in contact with the switch pattern 12. Because of this, the circuit of the switch pattern 12 becomes electroconductive and an input signal is sent to the electronic device in which the illumination switch 10 is installed.

The surface protective film 21 is composed of polyethylene terephthalate (PET).

The transparent electrode 22 is composed from indium tin oxide (IT) and is formed on the surface protective film 21.

The luminous layer 23 is composed from luminous ink and is formed on the transparent electrode 22. The luminous ink of the luminous layer 23 is formed of a stirred mixture of zinc sulfide (ZnS) doped with Cu and a fluororesin binder. The fluororesin binder is a copolymer of vinylidene fluoride and hexafluoropropylene dissolved in a methyl ethyl ketone.

The insulation layer 24 is formed between the luminous layer 23 and the back plate 25. The insulation layer 24 is formed from a mixture of a highly dielectric matter composed of barium titanate (BaTiO₃) and a fluororesin binder.

The back plate 25 is composed of carbon ink in which a polyester and carbon powder as a binder are mixed and is formed between the insulation layer 24 and the electrode insulation layer 26. When a voltage is applied between the back plate 25 and the transparent electrode 22, the luminous layer 23 emits light. Additionally, this embodiment is not limited to carbon powder. Carbon powder and copper powder, silver powder and aluminum powder may be mixed together and dispersed in the polyester.

The shield layer 27 is composed of carbon or aluminum and is formed between the electrode insulation layer 26 and the tooth-back protective film 28. The shield layer 27 is connected electronically to a ground electrode not shown in the diagram formed on the substrate 11 and shields the electromagnetic wave noise caused to be emitted from the EL sheet 14.

Furthermore, as shown in FIGS. 1 and 2, the shield layer 27 has an opening 27a in the region opposite to the switch pattern 12 and the movable contact 13. The opening 27a of the shield layer 27 corresponds to the region in which the domed part 14a of the EL sheet 14 and is formed in the vicinity of the boundary of the domed part 14a and the sheet part 14b. Consequently, the opening 27a has almost the same diameter as the domed part 14a.

If the opening 27a of the shield layer 27 is formed on a large scale, effectiveness of shielding the electromagnetic wave noise is reduced. On the other hand, if formed in a small scale, it is not possible to obtain a satisfactory click feeling. As a result, in this embodiment the opening 27a of the shield layer 27 is formed to have almost the same diameter as the domed part 14a. Specifically, because in this embodiment the domed part 14a of the EL sheet 14 is formed separated on the order of 1 mm from the movable contact 13, the diameter of the opening 27a of the shield layer 27 is also formed on the order of 6 mm.

The tooth-back protective film 28 is composed of polyethylene terephthalate and is formed on the underside of the shield layer 27 and the underside of the electrode insulation layer 26.

In the illumination switch 10 of this invention with the above structure, the shield layer 27 has an opening 27a in the region opposite to the movable contact 13 and the shield layer 27 is formed to shield the noise only in the sheet part 14b from which the domed part 14a of the EL sheet 14 is excluded. In this manner, because the shield layer 27 with strong stiffness is not formed on the domed part 14a which is elastically deformed as a switch, the stiffness of the domed part 14a is not excessively strong and it is possible to obtain a satisfactory click feeling.

Furthermore, the opening 27a of the shield layer 27 of the EL sheet 14 of this invention is formed in the vicinity of the boundary between the domed part 14a and the sheet part 14b. In other words, because the shield layer 27 is formed so as to reach the boundary between the domed part 14a and the sheet part 14b, it is possible to satisfactorily shield the electromagnetic wave noise emanating from the EL sheet 14. Consequently, an illumination switch 10 is realized in which the electromagnetic wave noise is effectively shielded and with which it is possible to get an excellent click feeling.

With this invention various modifications and applications are possible without being limited to the embodiment described above. For example, in the embodiment described above an explanation was given citing an example in which the shield layer 27 corresponds to the region in which the domed part 14a of the EL sheet 14 is formed and is structured to have almost the same diameter as the domed part 14a but it is not limited to this. For example, it is also possible for the opening 27a of the shield layer 27 to be smaller than that of the embodiment explained above and to be formed only on the apex of the domed part 14a. Furthermore, contrastingly, the opening 27a of the shield part 27 may be formed so as to have a diameter even larger than the domed part 14a and may be formed in a range containing at least the domed part 14a. Consideration was also given to the properties of the stiffness of the EL sheet 14 and the form of the domed part 14a regarding the extent to which the opening 27a of the shield layer 27 was to be formed, and it was determined that an excellent click feeling could be obtained and the electromagnetic wave noise satisfactorily shielded.

Additionally, an explanation was given citing an example of the structure of the movable contact 13 in which electroconductive material was mixed in with elastic material but it is not limited to this. A structure may be obtained in which the domed shape material may be formed by PET and aluminum may be caused to be vaporized and deposited inside the domed shape material forming an electrode. Furthermore, this invention is not limited to the vapor deposition of aluminum. An electrode may be formed by applying a mixture of carbon in, for example, rubber inside the dome shaped material.

The movable contact 13 is not limited to being composed of polyurethane rubber but, for example, polyolefin elastomers, polyester elastomers and fluorinated elastomers may also be used. In addition, nickel, copper, gold, silver and tine may also be used as the electroconductive material.

Furthermore, the present application claims priority based on Japanese Patent Application No. 2005-98615 filed on Mar. 30, 2005, the entire contents of which are incorporated herein by reference.

### INDUSTRIAL APPLICABILITY

This invention may be applied to an illumination switch that can shield electromagnetic wave noise caused to emanate from an EL sheet and with which it is possible to obtain an excellent click feeling.

1. An illumination switch comprising:
a substrate;
a switch pattern formed on the substrate;
an electrode facing the switch pattern and set up on the switch pattern so as to be detachable; and
an EL (electro-luminescence) sheet formed so as to cover the substrate, the switch pattern and the electrode,
wherein a shield layer to shield electromagnetic wave noise is set up on the EL sheet and an opening is formed in the shield layer in the region opposite to the electrode.

2. The illumination switch according to claim 1, wherein the EL sheet comprises a dome shaped region formed so as to cover the switch pattern and the electrode and a sheet shaped region formed so as to cover the substrate.

3. The illumination switch according to claim 2 wherein the opening of the shield layer has almost the same diameter as the dome shaped region.

4. The illumination switch according to claim 2 wherein the opening of the shield layer is formed in a range that contains at least the dome shaped region.

5. The illumination switch according to claim 2 wherein the opening of the shield layer is formed at the apex of the dome shaped region.
